(19) United States
(12) Patent Application Publication
(10) Pub. No.: US 2026/0186161 A1
(43) Pub. Date: Jul. 2, 2026

(54) METHODS AND SYSTEMS FOR GENERATING SEISMIC ATTRIBUTES WITH NARROW-BAND WAVE PROPAGATION

(71) Applicant: BP Corporation North America Inc., Houston, TX (US)

(72) Inventors: John Etgen, Houston, TX (US); Reetam Biswas, Katy, TX (US)

(73) Assignee: BP Corporation North America Inc., Houston, TX (US)

(21) Appl. No.: 19/433,453

(22) Filed: Dec. 26, 2025

Related U.S. Application Data
(60) Provisional application No. 63/741,368, filed on Jan. 2, 2025.

(51) Int. Cl. G01V 1/34; G01V 1/28; G01V 1/30

(52) U.S. Cl. CPC G01V 1/345; G01V 1/282; G01V 1/303; G01V 2210/675

(57) ABSTRACT

A method includes receiving observed seismic data from a subsurface region captured by one or more seismic receivers as one or more reflected seismic signals, decomposing the observed seismic data into a plurality of separate seismic frequency bands, determining a set of FD coefficients by numerically solving the seismic wave equation using a velocity model of the subsurface region for each of the plurality of seismic frequency bands, determining forward propagated modeled seismic data using the set of FD coefficients, determining reverse-time propagated observed seismic data using the set of FD coefficients and the observed seismic data, determining a set of frequency band seismic attributes from the forward propagated modeled seismic data and the reverse-time propagated observed seismic data, and combining the set of frequency band seismic attributes to complete seismic attribute.

### CROSS-REFERENCE TO RELATED APPLICATIONS

This application is a non-provisional patent application which claims benefit of U.S. provisional patent application No. 63/741,368 filed Jan. 2, 2025, and entitled “Methods and Systems for Generating Seismic Attributes with Narrow-Band Wave Propagation”, which is incorporated herein in its entirety for all purposes.

### BACKGROUND

Seismic surveying is a method of exploration geophysics in which seismology is used to estimate properties of earthen subsurface regions from reflected seismic waves. Seismic surveying generally includes imparting acoustic or sound waves into a natural environment so that the waves enter the Earth and travel through a subsurface region of interest. As the seismic waves encounter an interface between two materials of the subsurface region, some of the wave energy is reflected off of the interface where the reflected wave energy may be observed or collected at the surface as seismic data associated with the subsurface region, while some of the wave energy refracts through the interface and penetrates deeper into the subsurface region. The reflected wave energy observed at the surface as seismic data may be studied to ascertain information about the subsurface region. For example, the observed seismic data may be used to construct a velocity model of the subsurface region which models the velocity of the seismic waves passing through the subsurface region so as to translate subsurface reflection points of the seismic waves to their true depth within the formation. The seismic data observed by the receivers may also be used to create an image or profile of the corresponding subsurface region. Interpretation of these seismic images may provide a description of the geological features of the subsurface, such as faults, salts domes, anticlines, or other features indicative of the location and/or change in hydrocarbon deposits.

### SUMMARY

An embodiment of a method for generating modeled seismic wavefields and data as well as propagating observed seismic data by numerically solving the seismic wave equation across a plurality of separate frequency bands comprises (a) receiving observed seismic data from a subsurface region captured by one or more seismic receivers as one or more reflected seismic signals, (b) decomposing the observed seismic data into a plurality of separate seismic frequency bands, (c) determining a set of finite-difference (FD) coefficients by numerically solving the seismic wave equation using a velocity model of the subsurface region for each of the plurality of seismic frequency bands, (d) determining forward propagated modeled seismic data using the set of FD coefficients, (e) determining reverse-time propagated observed seismic data using the set of FD coefficients and the observed seismic data, (f) determining a set of frequency band seismic attributes from the forward propagated modeled seismic data and the reverse-time propagated observed seismic data, and (g) combining the set of frequency band seismic attributes to complete seismic attribute. In some embodiments, the complete seismic attribute comprises a seismic image of the subsurface region. In some embodiments, a frequency range of each of the plurality of seismic frequency bands is between 3% and 20% of an overall frequency range of the observed seismic data. In certain embodiments, a frequency range of each of the plurality of seismic frequency bands is between 2 Hertz (Hz) and 10 Hz. In certain embodiments, each of the plurality of seismic frequency bands has a unique frequency range that overlaps with the frequency range of another of the plurality of seismic frequency bands. In some embodiments, (c) comprises applying an optimization algorithm to iteratively minimize an error between an analytical velocity and a numerical seismic velocity for each of the plurality of seismic frequency bands. In some embodiments, the optimization algorithm comprises a least-squares optimization algorithm. In certain embodiments, each of the set of frequency band seismic attributes have a triangular spectral shape. In certain embodiments, (b) comprises (b1) determining a seismic gather from the observed seismic data, the seismic gather extending across an overall frequency range, and (b2) decomposing the seismic gather into a plurality of separate seismic frequency bands each having a frequency range contained in the overall frequency range. In some embodiments, (f) comprises (f1) determining forward propagated modeled seismic data for each of the plurality of seismic frequency bands using the set of FD coefficients, (f2) determining reverse-time propagated modeled seismic data for each of the plurality of seismic frequency bands using the set of FD coefficients, and (f3) determining the set of frequency band seismic attributes by combining the forward propagated modeled seismic data with the reverse-time propagated seismic data. In some embodiments, the method comprises (h) separately weighting the set of frequency band seismic attributes to provide a set of weighted frequency band seismic attributes, wherein (e) comprises combining the set of frequency band seismic attributes to complete seismic attribute.

An embodiment of a method for generating modeled seismic data from observed seismic data by numerically solving the seismic wave equation across a plurality of separate frequency bands comprises (a) receiving observed seismic data from a subsurface region captured by one or more seismic receivers as one or more reflected seismic signals, (b) decomposing the observed seismic data into a plurality of separate seismic frequency bands, (c) determining a set of frequency band seismic attributes from the plurality of seismic frequency bands, (d) separately weighting the set of frequency band seismic attributes to provide a set of weighted frequency band seismic attributes, and (e) combining the set of weighted frequency band seismic attributes to complete weighted seismic attribute. In certain embodiments, the complete seismic attribute comprises a seismic image of the subsurface region. In certain embodiments, a frequency range of each of the plurality of seismic frequency bands is between 3% and 20% of an overall frequency range of the observed seismic data. In some embodiments, a frequency range of each of the plurality of seismic frequency bands is between 2 Hertz (Hz) and 10 Hz. In some embodiments, each of the plurality of seismic frequency bands has a unique frequency range that overlaps with the frequency range of another of the plurality of seismic frequency bands. In certain embodiments, (d) comprises adjusting a spectral shape of one or more of the set of frequency band seismic attributes. In certain embodiments, (d) comprises adjusting an amplitude of a central frequency of one or more of the set of frequency band seismic attributes.

An embodiment of a system comprises one or more processors, and a storage device coupled to the one or more processors, the storage device configured to store instructions that, when executed by the one or more processors, configure the one or more processors to (a) receive observed seismic data from a subsurface region captured by one or more seismic receivers as one or more reflected seismic signals, (b) decompose the observed seismic data into a plurality of separate seismic frequency bands, (c) determine a set of finite-difference (FD) coefficients by numerically solving a

seismic wave equation using a velocity model of the subsurface region for each of the plurality of seismic frequency bands, (d) determine forward propagated modeled seismic data using the set of FD coefficients, (e) determine reverse-time propagated observed seismic data using the set of FD coefficients and the observed seismic data, (f) determine a set of frequency band seismic attributes from the forward propagated modeled seismic data and the reverse-time propagated observed seismic data, and (g) combine the set of frequency band seismic attributes to complete seismic attribute. In some embodiments, at least one of a frequency range of each of the plurality of seismic frequency bands is between 3% and 20% of an overall frequency range of the observed seismic data, and the frequency range of each of the plurality of seismic frequency bands is between 2 Hertz (Hz) and 10 Hz.

### BRIEF DESCRIPTION OF THE DRAWINGS

For a detailed description of various exemplary embodiments, reference will now be made to the accompanying drawings in which:

FIG. 1 is a flow chart of various processes that may be performed based on analysis of seismic data acquired via a seismic survey system in accordance with principles disclosed herein;

FIG. 2 is a schematic diagram of an embodiment of a system for performing a marine seismic survey in accordance with principles disclosed herein;

FIG. 3 is a schematic diagram of an embodiment of a system for performing a land-based seismic survey in accordance with principles disclosed herein;

FIG. 4 is a block diagram of an embodiment of a computer system that may perform operations described herein based on data acquired via the marine survey system of FIG. 2 and/or the land survey systems of FIG. 3 in accordance with principles disclosed herein;

FIGS. 5A and 5B are a flowchart illustrating a method for generating modeled seismic wavefields and data as well as propagating observed seismic data by numerically solving the seismic wave equation across a plurality of separate frequency bands in accordance with principles disclosed herein;

FIG. 6 is an exemplary finite-difference (FD) coefficient table in accordance with principles disclosed herein;

FIG. 7 is a graph illustrating an exemplary synthetic wavelet in accordance with principles disclosed herein;

FIG. 8 is a graph illustrating exemplary wavelet frequency spectra in accordance with principles disclosed herein;

FIG. 9 is a graph illustrating another exemplary synthetic wavelet in accordance with principles disclosed herein;

FIG. 10 is a graph illustrating exemplary wavelet frequency spectra in accordance with principles disclosed herein;

FIGS. 11-16 are graphs illustrating exemplary modeled seismic data for different frequency bands in accordance with principles disclosed herein;

FIG. 17 is graph illustrating the sum of the modeled seismic data for the different frequency bands represented in FIGS. 11-16 in accordance with principles disclosed herein;

FIG. 18 is a graph illustrating exemplary broadband modeled seismic data in accordance with principles disclosed herein; and

FIGS. 19 and 20 are flowcharts of methods for generating modeled seismic data from observed seismic data by numerically solving the seismic wave equation across a plurality of separate frequency bands in accordance with principles disclosed herein.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in the interest of clarity and conciseness.

In the following discussion and in the claims, the terms “including” and “comprising” are used in an open-ended fashion, and thus should be interpreted to mean “including, but not limited to...” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a particular axis (e.g., central axis of a body or a port), while the terms “radial” and “radially” generally mean perpendicular to a particular axis. For instance, an axial distance refers to a distance measured along or parallel to the axis, and a radial distance means a distance measured perpendicular to the axis. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

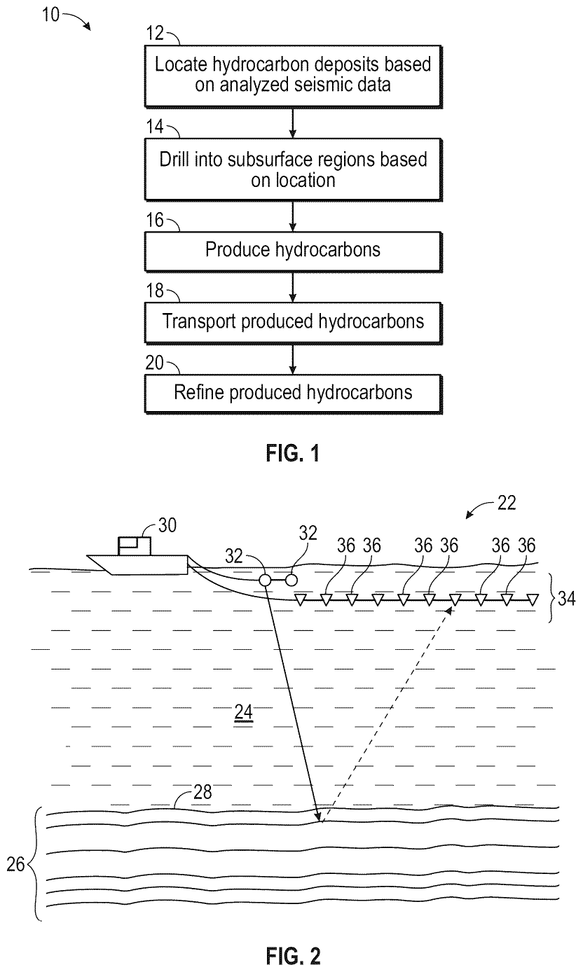

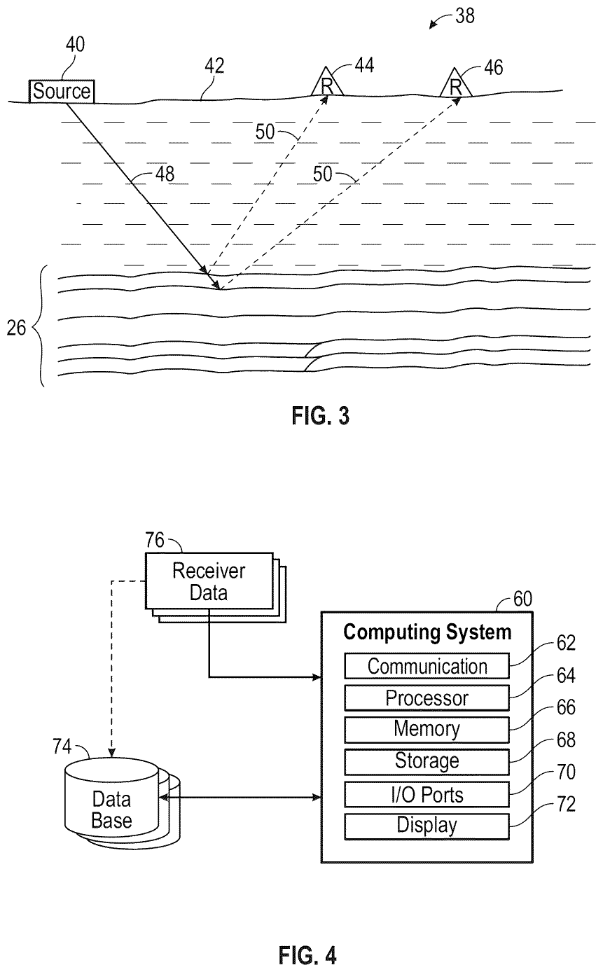

By way of introduction, seismic data may be acquired using a variety of seismic survey systems and techniques, two of which are discussed with respect to FIG. 2 and FIG. 3. Regardless of the seismic data gathering technique utilized, after the seismic data is acquired, a computing system may analyze the acquired seismic data and may use the results of the seismic data analysis (e.g., seismogram, map of geological formations, etc.) to perform various operations within the hydrocarbon exploration and production industries. For instance, FIG. 1 illustrates a flow chart of a method 10 that details various processes that may be undertaken based on the analysis of the acquired seismic data. Although the method 10 is described in a particular order, it should be noted that the method 10 may be performed in any suitable order.

Referring now to FIG. 1, at block 12, locations and properties of hydrocarbon deposits within a subsurface region of the Earth associated with the respective seismic survey may be determined based on the analyzed seismic data. In one embodiment, the seismic data acquired may be analyzed to generate a map or profile that illustrates various geological formations within the subsurface region. Based on the identified locations and properties of the hydrocarbon deposits, at block 14, certain positions or parts of the subsurface region may be explored. That is, hydrocarbon exploration organizations may use the locations of the hydrocarbon deposits to determine locations at the surface of the subsurface region to drill into the Earth. As such, the hydrocarbon exploration organizations may use the locations and properties of the hydrocarbon deposits and the associated overburdens to determine a path along which to drill into the Earth, how to drill into the Earth, and the like.

After exploration equipment has been placed within the subsurface region, at block 16, the hydrocarbons that are stored in the hydrocarbon deposits may be produced via natural flowing wells, artificial lift wells, and the like. At block 18, the produced hydrocarbons may be transported to refineries and the like via transport vehicles, pipelines, and the like. At block 20, the produced hydrocarbons may be processed according to various refining procedures to develop different products using the hydrocarbons.

It should be noted that the processes discussed with regard to the method 10 may include other suitable processes that may be based on the locations and properties of hydrocarbon deposits as indicated in the seismic data acquired via one or more seismic survey. As such, it should be understood that the processes described above are not intended to depict an exhaustive list of processes that may be performed after determining the locations and properties of hydrocarbon deposits within the subsurface region.

With the foregoing in mind, FIG. 2 is a schematic diagram of a marine survey system 22 (e.g., for use in conjunction with block 12 of FIG. 1) that may be employed to acquire seismic data (e.g., waveforms) regarding a subsurface region of the Earth in a marine environment. Generally, a marine seismic survey using the marine survey system 22 may be conducted in an ocean 24 or other body of water over a subsurface region 26 of the Earth that lies beneath a seafloor 28.

The marine survey system 22 may include a vessel 30, one or more seismic sources 32, a (seismic) streamer 34, one or more (seismic) receivers 36, and/or other equipment that may assist in acquiring seismic images representative of geological formations within a subsurface region 26 of the Earth. The vessel 30 may tow the seismic source(s) 32 (e.g., an air gun array) that may produce energy, such as sound waves (e.g., seismic waveforms), that is directed at a seafloor 28. The vessel 30 may also tow the seismic streamer 34 having a receiver 36 (e.g., hydrophones) that may acquire seismic waveforms that represent the energy output by the seismic source(s) 32 subsequent to being reflected off of various geological formations (e.g., salt domes, faults, folds, etc., represented schematically in FIG. 2 as subsurface reflectors 29) within the subsurface region 26. Additionally, although the description of the marine survey system 22 is described with one seismic source 32 (represented in FIG. 2 as an air gun array) and one receiver 36 (represented in FIG. 2 as a set of hydrophones), it should be noted that the marine survey system 22 may include multiple seismic sources 32 and multiple receivers 36. In the same manner, although the above descriptions of the marine survey system 22 is described with one seismic streamer 34, it should be noted that the marine survey system 22 may include multiple streamers similar to seismic streamer 34. In addition, additional vessels 30 may include additional seismic source(s) 32, seismic streamer(s) 34, and the like to perform the operations of the marine survey system 22.

FIG. 3 is a block diagram of a land survey system 38 (e.g., for use in conjunction with block 12 of FIG. 1) that may be employed to obtain information regarding the subsurface region 26 of the Earth in a non-marine environment. The land survey system 38 may include a land-based seismic source 40 and land-based receiver 44. In some embodiments, the land survey system 38 may include multiple land-based seismic sources 40 and one or more land-based receivers 44 and 46. Indeed, for discussion purposes, the land survey system 38 includes a land-based seismic source 40 and two land-based receivers 44 and 46. The land-based seismic source 40 (e.g., seismic vibrator) that may be disposed on a surface 42 of the Earth above the subsurface region 26 of interest. The land-based seismic source 40 may produce energy (e.g., sound waves, seismic waveforms) that is directed at the subsurface region 26 of the Earth. Upon reaching various geological formations (e.g., salt domes, faults, folds) within the subsurface region 26 the energy output by the land-based seismic source 40 may be reflected off of the geological formations (e.g., subsurface reflectors 29) and acquired or observed by one or more land-based receivers (e.g., 44 and 46).

In certain embodiments, the land-based receivers 44 and 46 may be dispersed across the surface 42 of the Earth to form a grid-like pattern. As such, each land-based seismic receiver 44 or 46 may receive a reflected seismic waveform in response to energy being directed at the subsurface region 26 via the seismic source 40. In some cases, one seismic waveform produced by the seismic source 40 may be reflected off of different geological formations and received by different seismic receivers. For example, as shown in FIG. 3, the seismic source 40 may output energy that may be directed at the subsurface region 26 as seismic waveform 48. A first seismic receiver 44 may receive the reflection of the seismic waveform 48 off of one geological formation and a second seismic receiver 46 may receive the reflection of the seismic waveform 48 off of a different geological formation. As such, the first seismic receiver 44 may receive a reflected seismic waveform 50 and the second seismic receiver 46 may receive a reflected seismic waveform 52.

Regardless of how the seismic data is acquired, a computing system (e.g., for use in conjunction with block 12 of FIG. 1) may analyze the seismic waveforms acquired by the seismic receivers 36, 44, 46 to determine seismic information regarding the geological structure, the location and property of hydrocarbon deposits, and the like within the subsurface region 26. FIG. 4 is a block diagram of an example of such a computing system 60 that may perform various data analysis operations to analyze the seismic data acquired by the seismic receivers 36, 44, 46 to determine the structure and/or predict seismic properties of the geological formations within the subsurface region 26.

Referring now to FIG. 4, the computing system 60 may include a communication component 62, a processor 64, memory 66, storage 68, input/output (I/O) ports 70, and a display 72. In certain embodiments, the computing system 60 may omit one or more of the display 72, the communication component 62, and/or the input/output (I/O) ports 70. The communication component 62 may be a wireless or wired communication component that may facilitate communication between the seismic receivers 36, 44, 46, one or more databases 74, other computing devices, and/or other communication capable devices. In one embodiment, the computing system 60 may receive seismic receiver data 76 (e.g., seismic data, seismograms, etc.) via a network component, the database 74, or the like. The processor 64 of the computing system 60 may analyze or process the seismic receiver data 76 to ascertain various features regarding geological formations within the subsurface region 26 of the Earth.

The processor 64 may be any type of computer processor or microprocessor capable of executing computer-executable code. The processor 64 may also include multiple processors that may perform the operations described below. The memory 66 and the storage 68 may be any suitable articles of manufacture that can serve as media to store processor-executable code, data, or the like. These articles of manufacture may represent computer-readable media (e.g., any suitable form of memory or storage) that may store the processor-executable code used by the processor 64 to perform the presently disclosed techniques. Generally, the processor 64 may execute software applications that include programs that process seismic data acquired via seismic receivers of a seismic survey according to the embodiments described herein.

With one or more embodiments, processor 64 can instantiate or operate in conjunction with one or more seismic inversion techniques. With another embodiment, the computing system 60 can be implemented by using neural networks. The one or more neural networks can be software-implemented or hardware-implemented. One or more of the neural networks can be a convolutional neural network.

The memory 66 and the storage 68 may also be used to store the data, analysis of the data, the software applications, and the like. The memory 66 and the storage 68 may represent non-transitory computer-readable media (e.g., any suitable form of memory or storage) that may store the processor-executable code used by the processor 64 to perform various techniques described herein. It should be noted that non-transitory merely indicates that the media is tangible and not a signal.

The I/O ports 70 may be interfaces that may couple to other peripheral components such as input devices (e.g., keyboard, mouse), sensors, input/output (I/O) modules, and the like. I/O ports 70 may enable the computing system 60 to communicate with the other devices in the marine survey system 22, the land survey system 38, or the like via the I/O ports 70.

The display 72 may depict visualizations associated with software or executable code being processed by the processor 64. In one embodiment, the display 72 may be a touch display capable of receiving inputs from a user of the computing system 60. The display 72 may also be used to view and analyze results of the analysis of the acquired seismic data to determine the geological formations within the subsurface region 26, the location and property of hydrocarbon deposits within the subsurface region 26, predictions of seismic properties associated with one or more wells in the subsurface region 26, and the like. The display 72 may be any suitable type of display, such as a liquid crystal display (LCD), plasma display, or an organic light emitting diode (OLED) display, for example. In addition to depicting the visualization described herein via the display 72, it should be noted that the computing system 60 may also depict the visualization via other tangible elements, such as paper (e.g., via printing) and the like.

With the foregoing in mind, the present techniques described herein may also be performed using a supercomputer that employs multiple computing systems 60, a cloud-computing system, or the like to distribute processes to be performed across multiple computing systems 60. In this case, each computing system 60 operating as part of a super computer may not include each component listed as part of the computing system 60. For example, each computing system 60 may not include the display 72 since multiple displays 72 may not be useful to for a supercomputer designed to continuously process seismic data.

After performing various types of seismic data processing, the computing system 60 may store the results of the analysis in one or more databases 74. The databases 74 may be communicatively coupled to a network that may transmit and receive data to and from the computing system 60 via the communication component 62. In addition, the databases 74 may store information regarding the subsurface region 26, such as previous seismograms, geological sample data, seismic images, and the like regarding the subsurface region 26.

Although the components described above have been discussed with regard to the computing system 60, it should be noted that similar components may make up the computing system 60. Moreover, the computing system 60 may also be part of the marine survey system 22 or the land survey system 38, and thus may monitor and control certain operations of the seismic sources 32 or 40, the seismic receivers 36, 44, 46, and the like. Further, it should be noted that the listed components are provided as example components and the embodiments described herein are not to be limited to the components described with reference to FIG. 4.

In some embodiments, the computing system 60 may generate a two-dimensional representation or a three-dimensional representation of the subsurface region 26 based on the seismic data received via the seismic receivers mentioned above. Additionally, seismic data associated with multiple source/receiver combinations may be combined to create a near continuous profile of the subsurface region 26 that can extend for some distance. In a two-dimensional (2-D) seismic survey, the seismic receiver locations may be placed along a single line, whereas in a three-dimensional (3-D) survey the seismic receiver locations may be distributed across the surface in a grid pattern. As such, a 2-D seismic survey may provide a cross sectional picture (vertical slice) of the Earth layers as they exist directly beneath the recording locations. A 3-D seismic survey, on the other hand, may create a data “cube” or volume that may correspond to a 3-D picture of the subsurface region 26.

In addition, a 4-D (or time-lapse) seismic survey may include seismic data acquired during a 3-D survey at multiple times. Using the different seismic images acquired at different times, the computing system 60 may compare the two images to identify changes in the subsurface region 26.

In any case, a seismic survey may be composed of a very large number of individual seismic recordings or traces. As such, the computing system 60 may be employed to analyze the acquired seismic data to obtain an image representative of the subsurface region 26 and to determine locations and properties of hydrocarbon deposits. To that end, a variety of seismic data processing algorithms may be used to remove noise from the acquired seismic data, migrate the pre-processed seismic data, identify shifts between multiple seismic images, align multiple seismic images, and the like.

After the computing system 60 analyzes the acquired seismic data, the results of the seismic data analysis (e.g., seismogram, seismic images, map of geological formations, etc.) may be used to perform various operations within the hydrocarbon exploration and production industries. For instance, as described above, the acquired seismic data may be used to perform the method 10 of FIG. 1 that details various processes that may be undertaken based on the analysis of the acquired seismic data.

As described above, seismic surveys reflect seismic waves off of features of earthen subsurface regions in order to collect information regarding the subsurface regions. The information collected from the reflected seismic waves may be used to create velocity models and seismic images which may be used to identify subterranean features of interest such as, for example, hydrocarbon deposits.

Seismic surveys often incorporate seismic migration processes and seismic inversion processes in order to construct accurate seismic images and velocity models. Particularly, seismic migration aims to accurately reconstruct the spatial location of subsurface features from seismic reflection data. For instance, during a seismic survey, seismic waves are generated at the surface and travel through subsurface layers, reflecting off various subsurface features or reflectors (e.g., geological boundaries). These subsurface reflections are recorded later at the surface, creating a dataset that represents wave amplitudes over time at different locations. However, due to complex paths taken by the waves, these data points do not directly correspond to the true spatial positions of the reflecting surfaces. The recorded reflections correspond to observed seismic data. As used herein, “observed seismic data” refers to data that is captured by one or more seismic receivers as seismic signals reflected by the subsurface region and which are originally generated by one or more corresponding sources. Thus, as used herein, “seismic migration” refers to a seismic data processing technique which shift or relocate seismic reflections captured in the observed seismic data towards their true physical positions in the subsurface region in order to create an image thereof.

Additionally, seismic inversion is a technique that estimates the physical properties (e.g., acoustic impedance, density, and/or velocity) of a subsurface region, based on observed seismic data. Generally, the goal of seismic inversion is to translate observed seismic data into a subsurface model (e.g., a velocity model) that quantitatively describes the properties of the subsurface region which may be indicative of rock type, fluid content, porosity, and the like. In practice, seismic inversion produces models that inform the seismic surveyor of the subsurface's composition rather than the location and geometry of subsurface features present within the subsurface region. Thus, as used herein, “seismic inversion” refers to data processing techniques that use observed seismic data to estimate physical properties (e.g., impedance, density, and velocity) of a subsurface region by modeling how the seismic waves physically interact with the subsurface region.

The seismic wave equation is leveraged in seismic migration, seismic inversion, and other techniques related to seismic surveying. Specifically, the seismic wave equation models how seismic waves propagate through subsurface regions. In other words, the seismic wave equation describes the relationship between a seismic wave's displacement over time and the properties (e.g., density and elasticity) of the medium the seismic wave travels through. The seismic wave equation is central to seismic surveying processes because it enables calculations of how seismic waves interact with underground structures. For instance, by solving the seismic wave equation, seismic migration can reposition observed seismic data to its true subsurface location. Similarly, seismic inversion uses the seismic wave equation to iteratively adjust a model of the subsurface properties (e.g., velocity) until simulated seismic wave behavior aligns with the observed seismic data, enabling detailed imaging and property estimation.

The seismic wave equation, while instrumental in varying seismic surveying techniques, is typically impractical to solve analytically (the seismic wave equation comprising a partial differential equation) in view of the complexity and heterogeneity of typical subsurface regions. Instead, numerical methods (e.g., finite-difference methods) are employed to estimate or approximate solutions to the seismic wave equation with high fidelity as part of seismic migration, seismic inversion and other seismic surveying techniques. Such numerical approximations or estimates of the seismic wave equation are referred to herein as “numerical solutions” to the seismic wave equation. Such numerical solutions produce modeled seismic data from the velocity model and other subsurface elastic properties that may inform the seismic surveyor of useful information regarding a subsurface region such as imaging of subsurface features and/or estimates of physical properties of the subsurface region.

Generally, finite-difference methods numerically solve the seismic wave equation by discretizing the seismic wave equation in both space and either time or frequency. Discretizing the seismic wave equation into space and time/frequency enables the determination of numerical solution of the seismic wave equation that simulates seismic wave propagation across a defined computational grid. Particularly, instead of needing to analytically solve derivatives of the seismic wave equation, finite-difference methods utilize weighted finite difference operators, where the finite-difference coefficients (“FD coefficients”) act as weights that approximate the derivatives of functions when numerically solving the seismic wave equation. Generally, the length of the finite difference expansion and the FD coefficients determine the accuracy of the approximated solution by defining how each point in a grid relates to its neighboring points. In seismic surveying applications, FD coefficients are typically required for calculating spatial and temporal derivatives of the seismic wave equation over a discretized model of the subsurface region.

Additionally, numerical methods are generally divided into two primary approaches: frequency-domain and time-domain finite-difference solutions. In the frequency domain, the seismic wave equation is typically transformed from a function of time and space to a function of frequency and space by applying a Fourier transform to the time variable of the seismic wave equation. This technique thereby converts the time-dependent seismic wave equation into a discrete set of Helmholtz equations, each associated with a unique frequency of the overall frequency range encompassing the observed seismic data. While providing high precision and fidelity for frequency-dependent phenomena, solving the resulting set of Helmholtz equations typically involves solving large, sparse systems of linear equations for each frequency, often using methods like lower-upper (LU) decomposition, conjugate gradient methods, and/or multigrid solvers to handle high computational loads. Thus, existing frequency-domain solutions can be computationally expensive in at least some applications (e.g., applications involving broad frequency ranges), as each frequency component requires a separate solution.

Conversely, time-domain techniques numerically solve the seismic wave equation across a discretized time grid, computing all frequencies simultaneously by extrapolating solutions iteratively after in time. Existing time-domain solutions directly model the seismic wavefield as it propagates through the computational grid and can be useful for applications where the full wavefield spectrum is essential, such as full-waveform inversion (FWI) or dynamic imaging in complex geologies. While the ability of time-domain solutions to inherently capture the entire frequency spectrum of the wavefield can be beneficial for certain applications (like FWI), such approaches may be disadvantageous when only specific frequency components are desired. Additionally, existing time-domain solutions typically require small time steps for stability, particularly when high frequencies or large domains are involved. This need for fine discretization, both in time and space, results in significant computational demands and memory usage.

Beyond excessive computational and memory demands, existing approaches to solving the seismic wave equation numerically for both time-domain and frequency-domain techniques is the limited ability to shape or tune the frequency spectrum of the resulting modeled seismic data after propagation is completed. Particularly, seismic waves typically are subject to high-frequency attenuation and/or other frequency-dependent distortions issues as the seismic waves propagate through the subsurface region, resulting in observed seismic data having a “red” or decreasing spectrum dominated by lower frequencies. The “broadband” modeled seismic data may be transformed into the wavenumber domain and the spectral content of the modeled seismic data may be reshaped in an attempt to correct for frequency-dependent distortions in the observed seismic data as part of a technique referred to as “spectral bluing”.

Spectral reshaping techniques such as spectral bluing may, however, result in the introduction of noise or artifacts into the modeled seismic data, reducing the fidelity of the modeled seismic data. For instance, transforming the modeled seismic data into the wavenumber domain (e.g., from the frequency domain) may result in the shifting of some high frequency content (which may be contaminated with noise or artifacts) into lower vertical wavenumbers due to spectral bluing. Additionally, while frequency domain techniques may be employed to avoid such issues, these alternative frequency domain techniques typically require the solving of elliptic partial differential equations that can be extremely computationally expensive to solve, generally limiting their usefulness. Further, while paraxial or approximate solutions could alternatively be utilized for these elliptic partial differential equations to reduce computational demands, the fidelity of such approximations is limited thus also limiting their usefulness.

Accordingly, embodiments are disclosed herein for generating modeled seismic wavefields and data by numerically solving the seismic wave equation across a plurality of discrete frequency bands contained within the broader frequency range of the observed seismic data to both minimize computational demands, using optimized FD coefficients along with compact spatial difference stencils while also permitting the direct shaping (rather than reshaping as with existing techniques such as spectral bluing) of the spectral content of the resulting modeled seismic data. For instance, observed seismic data extending across a frequency range of approximately 6 Hz and 60 Hz can be broken down by the proposed numerical solution into frequency bands that are several Hz (e.g., 2-8 Hz) in breadth with the seismic wave equation being numerically solved for each separate frequency band instead of, for instance, for individual frequencies as with existing frequency-domain solutions or across the entire frequency range as with existing time-domain solutions.

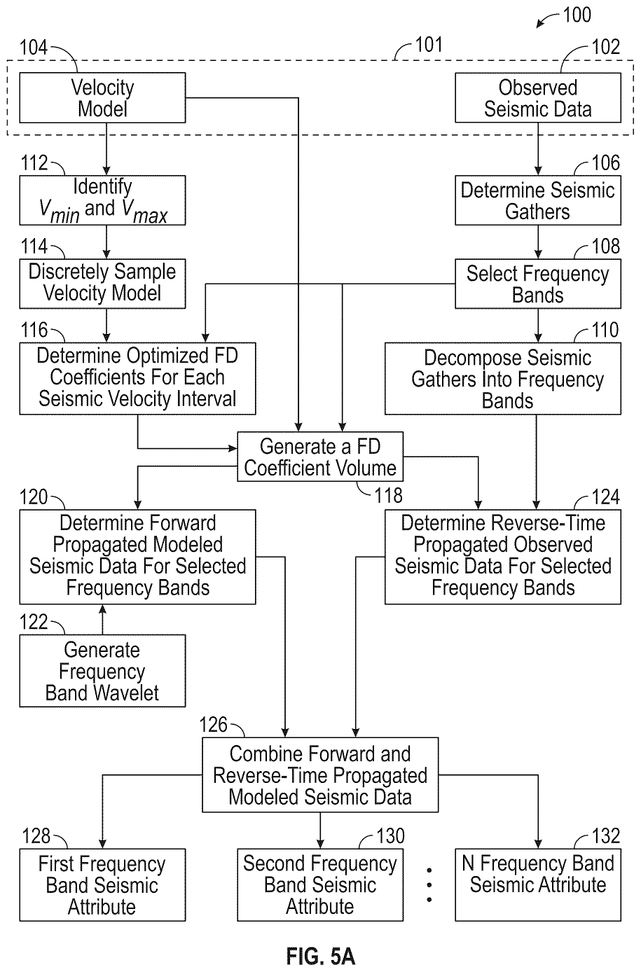

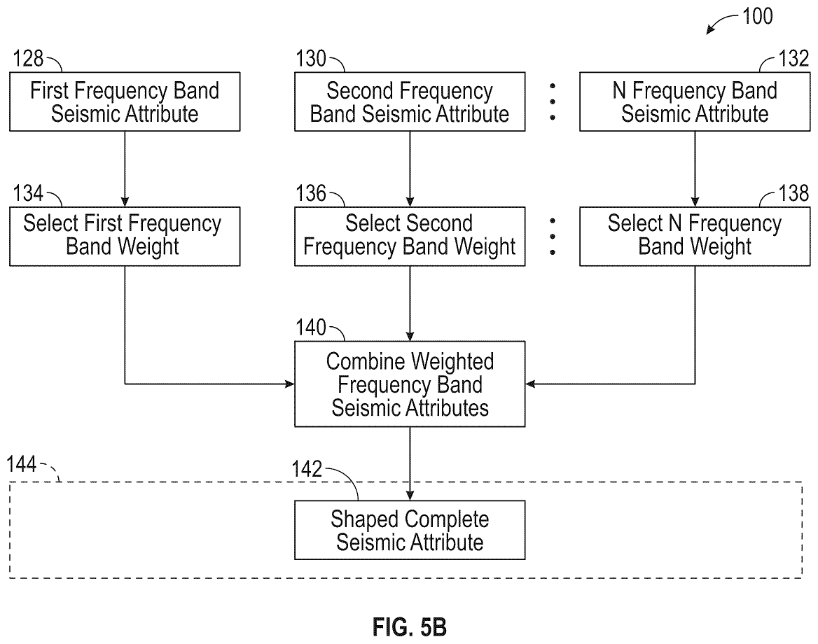

Referring now to FIGS. 5A and 5B, a method 100 for generating narrow band seismic images and attributes using modeled seismic data and observed seismic data by numerically solving the seismic wave equation for a plurality of separate frequency bands is shown according to some embodiments. At least some, if not all, of the steps or “blocks” of method 100 shown in FIGS. 5A and 5B may be executed by the computer system 60 shown in FIG. 4, although it is to be understood that at least some of the steps of method 100 may be executed by systems other than computer system 60.

Initially, method 100 includes an input layer 101 including blocks 102 and 104. Particularly, at block 102, method 100 includes receiving observed seismic data (e.g., seismic receiver data 76 shown in FIG. 4) obtained from a subsurface region (e.g., subsurface region 26). Additionally, at block 104, method 100 includes receiving a velocity model of the subsurface region. In some embodiments, velocity model from block 104 is constructed using the observed seismic data from block 102. For instance, an iterative process such as FWI may be applied to the observed seismic data from block 102 to build the velocity model from block 104 of the subsurface region.

At block 106, method 100 includes determining one or more seismic gathers from the observed seismic data 102 received at the input layer 101 of method 100. As used herein, the term “seismic gather” is defined as a collection or combination of different observed seismic attributes or data such as, for example, different observed seismograms or observed seismic traces. The seismic gathers determined from the observed seismic data 102 at block 106 may comprise “shot” seismic gathers or “receiver” seismic gathers. Shot seismic gathers refer to observed seismic data (e.g., observed seismic traces) recorded from a single shot or source location where the observed seismic data corresponds to different receiver locations. Conversely, receiver seismic gathers refer to observed seismic data recorded at a single receiver location from multiple shots at different source locations. In some embodiments, following the determination of the seismic gathers at block 106, method 100 additionally includes pre-processing the seismic gathers to filter or suppress noise contained therein.

At block 108, method 100 includes selecting (e.g., by a seismic surveyor) a plurality of frequency bands. Particularly, the seismic gathers received at block 108 have a frequency range that may extend, for example generally between 1 Hz and 100 Hz (e.g., between 6 Hz and 60 Hz) whereas each of the frequency bands selected at block 108 have a frequency range that is less than the overall frequency range of the seismic gather and which is contained in the overall frequency range of the seismic gather received at block 108. Each frequency band selected at block 108 has a unique central frequency and certain frequency range contained in the overall frequency range of the seismic gather. In certain embodiments, each frequency band selected at block 108 can have the same frequency range. In some embodiments, the frequency bands selected at block 108 partially overlap. To provide an example, block 108 could include, for a seismic gather having an overall frequency range extending between 6 Hz and 60 Hz, selecting frequency bands having a frequency range 4 Hz such that a first frequency band extends from 6 Hz to 10 Hz, a second frequency band extends between 8 Hz and 12 Hz, and so on until a final or “N” frequency band that extends from approximately 56 Hz to 60 Hz. In this example, each frequency band has a frequency range and a central frequency (e.g., 8 Hz and 10 Hz, respectively, for the first frequency band).

The frequency range of the different frequency bands as well as their degree of overlap may be selected at block 108 depending on the requirements of the given application. The frequency range of the different frequency bands may be selected depending on the need for accuracy compared to computational efficiency for the given application. For instance, frequency bands having a relatively narrow frequency range (e.g., 2 Hz) may have relatively greater accuracy than frequency bands having a broader frequency range (e.g., 10+ Hz) but at the cost of additional computation complexity. Particularly, broad frequency bands may result in numerical dispersion at the extremes of a given broad frequency band following the determination of the FD coefficient of the broad frequency band as a result of the FD coefficients failing to entirely cover the frequency range of the broad frequency band. However, such broad frequency bands require the performance of fewer computations and thus may be preferable in some applications where accuracy is less of a priority.

At block 110, method 100 includes decomposing each seismic gather determined at block 106 into a plurality of seismic gather bands corresponding to the frequency bands selected at block 108. In other words, the spectral content contained in a given seismic gather is decomposed or divided between the different frequency bands selected at block 108 to provide the plurality of seismic gather bands determined at block 110.

At block 112, method 100 includes identifying an estimated maximum seismic velocity (Vₘₐₓ) and an estimated minimum seismic velocity (Vₘᵢₙ) of the subsurface region using the velocity model from block 104 received at input layer 101 of method 100. For example, the velocity model from block 104 may comprise a grid or layered structure with each cell thereof assigned a seismic velocity such that the maximum and minimum seismic velocities of the velocity model from block 104 may be obtained simply by inspecting or interrogating the velocity model from block 104; however, other techniques may be employed in other embodiments for identifying the maximum and minimum seismic velocities of the subsurface region. At block 114, the velocity model from block 104 is discretely sampled. For instance, the velocity model from block 104 may be sampled at discrete seismic velocity intervals or increments (e.g., having a user-selected magnitude) where the magnitude of the discrete intervals corresponds to a step size or resolution of the sampled velocity model obtained at block 114. The magnitude of the seismic velocity increments selected at block 114 may be based on the desired accuracy of the modeled seismic data generated by method 100 with smaller seismic velocity increments providing a more accurate, but computationally expensive result.

At block 116, method 100 includes numerically determining optimized FD coefficients for each of the seismic velocity intervals (dV) at which the velocity model from block 104 was sampled at block 114. Additionally, the optimized FD coefficients determined at block 116 depend on the frequency bands selected at block 108. In this exemplary embodiment, the optimized FD coefficients determined at block 116 for the different seismic velocity intervals are based on the sampled seismic velocities of the different seismic velocity intervals determined at block 114; however, the inputs to block 116 may vary in other embodiments. For example, the optimized FD coefficients determined at block 116 may be obtained from the spatial and temporal discretization of the seismic wave equation which is based on the velocity model received at block 104, the minimum and maximum seismic velocities identified at block 112, and the sampled seismic velocities determined at block 114. In some embodiments, the sampled seismic velocities and corresponding optimized FD coefficients may be captured in a lookup table or other data structure organizing the sampled seismic velocities and optimized FD coefficients with their corresponding seismic velocity intervals. (

In some embodiments, block 116 is separately implemented for each frequency band selected at block 108 by iteratively minimizing a seismic phase velocity error between an analytical seismic velocity and a numerical seismic phase velocity (corresponding to a given optimized FD coefficient) for each seismic velocity increment contained in the given frequency band until the seismic velocity error achieves a predefined error threshold with the numerical seismic phase velocity of the final iteration corresponding to an optimized FD coefficient for the given seismic phase velocity. For instance, for a given seismic phase velocity and a frequency band extending between 2 Hz and 6 Hz, the seismic velocity error may be iteratively minimized for the optimized FD coefficients, and for all the velocity increments between the minimum seismic velocity and the maximum seismic velocity identified at block 112 to create a lookup table or other data structure for storing the optimized FD coefficients along with the corresponding discrete phase velocities. In certain embodiments, the process is repeated for all the identified frequency bands in the block 108

Additionally, block 118 may be separately performed or implemented for each of the frequency bands selected at block 108 such that a first instantiation of block 116 is implemented for the first frequency band, a second instantiation of block 116 is implemented for the second frequency band, and so on and so forth until a final instantiation of block 116 is implemented for the final or N frequency band selected at block 108.

In addition to iteratively minimizing the seismic velocity error for each seismic velocity increment falling within the velocity table of a given frequency band, and for all frequency bands, the seismic velocity error is also minimized for a plurality or set of different wave numbers and for each wave mode. Particularly, seismic waves may propagate through subsurface regions in accordance with different wave modes depending on the composition or configuration of the given subsurface region. For instance, subsurface regions that are purely compressional and lacking shear strength (e.g., fluid or fluid-saturated subsurface regions) generally only permit the propagation of seismic primary waves referred to as “P-waves” or quasi-primary waves (qP waves) that define compressional or longitudinal waves causing particles in the subsurface region to travel back and forth in the same direction as the P-wave's travel. The acoustic version of the seismic wave equation (or simply the “acoustic wave equation”) assumes a purely compressional subsurface region and thus the only wave mode relevant to the acoustic wave equation are P-waves.

However, in at least some instances, the subsurface region may have a demonstrable shear strength which permits for the propagation of seismic secondary/shear waves referred to as “S-waves” or quasi-shear (qS waves) as another wave mode which displace particles in a direction perpendicular to the direction of propagation of the S-wave. Particularly, S-waves include both quasi-shear horizontal waves (qSH waves) as a second wave mode describing particle motion that extends horizontally and perpendicular to both the direction of wave propagation and a vertical plane, and quasi-shear vertical waves (qSV waves) as a third wave mode describing particle motion that extends vertically and perpendicular to both the direction of wave propagation and the horizontal plane. S-waves are permitted to travel through solid physical mediums but generally do not travel through fluid or fluid-saturated mediums. Further, the elastic version of the seismic wave equation (or simply the “elastic wave equation”) assumes a generally solid and elastic medium through which both P-waves and S-waves are permitted to propagate.

Depending on the configuration of the subsurface region of the particular application (e.g., whether it is conducive to the propagation of only P-waves or both P-waves and S-waves) the seismic velocity error may be minimized for only the qP wave mode for numerically solving the acoustic wave equation, or for each of the qP, qSH, and qSV wave modes for numerically solving the elastic wave equation. Thus, in some instances, an optimized FD coefficient may be generated for only the qP wave mode while in other instances optimized FD coefficients may be determined for each of the qP, qSH, and qSV wave modes for each seismic velocity increment of the given frequency band.

Further, given that the subsurface region extends three-dimensionally through physical space, the seismic velocity error must be minimized (and a corresponding optimized FD coefficient obtained) for each of the three wave numbers (e.g., kₓ, k_{y}, and k_{z}) for each wave mode at each seismic velocity increment. Returning to the earlier example of a frequency band extending between 2 Hz and 6 Hz with a user-selected seismic velocity increment (dV), in an application utilizing the elastic wave equation an optimized FD coefficient would be determined at block 116 for each wave number (kₓ, k_{y}, and k_{z}) for each wave mode (qP, qSH, and qSH) at V+dV, V+2 dV, and so on and so forth. Alternatively, if the subsurface region were configured such that only the acoustic wave equation need be solved, then an optimized FD coefficient would be determined at block 116 for each wave number (kₓ, k_{y}, and k_{z}) of only the qP wave mode at V+dV, V+2 dV, and so on and so forth.

Beyond the number of applicable physical dimensions, the number of optimized FD coefficients determined at block 116 may also depend on the order of the (e.g., the radius of the stencil) for the derivative and the number of applicable dimensions (e.g., x, y, z dimensions). Generally, and not intending to be bound by any particular theory, the optimized FD coefficients define the weights used to calculate the derivatives of the wavefield for wave propagation modeling. Generally, additional length of the finite difference expansion generally provide a more accurate and precise solution, but come at substantial costs in computational complexity. The Taylor coefficients define the default weights for the weighted Taylor series expansion. Low order Taylor series expansions utilizing Taylor coefficients may provide accurate solutions at relatively low frequencies, but the error in the wavefield derivative generally increases at higher frequencies when using such low order Taylor series expansions with Taylor coefficients. Also, while using any finite difference stencils at low frequencies Taylor coefficients can act as a starting point but to further improve the accuracy of the wave propagation the coefficients need to be optimized. However, at high frequencies optimization is generally required.

Embodiments disclosed herein address this issue without needing to incur substantially increased computational costs (e.g., via using higher order finite difference series expansions) by using optimized FD coefficients rather than relying on the default Taylor coefficients. Particularly, the optimized FD coefficients minimize the numerical and analytical phase velocity error for narrow frequency bands (e.g., the frequency bands selected at block 108). This optimization may be performed for all seismic velocities between the minimum and maximum seismic velocities of a given velocity model (e.g., the minimum and maximum seismic velocities identified at block 112) by selected seismic increments (dV) for each of the narrow frequency bands. In some embodiments, block 116 produces a lookup table or other data structure containing a set of seismic velocity dependent, optimized FD coefficients for each of the frequency bands selected at block 108. In this manner, method 100 may leverage a compact spatial stencil with optimized FD coefficients to maximize the accuracy of the solution even at high frequencies.

Different optimization algorithms (e.g., algorithms for iteratively minimizing the seismic velocity error) may be utilized at block 116 for determining the different FD coefficients of each frequency band selected at block 108. For instance, in some embodiments, a least-squares optimization algorithm may be implemented at block 116 for determining the applicable optimized FD coefficients. Alternatively, optimization algorithms other than least-squares optimization algorithms may be implemented at block 116 for determining the applicable optimized FD coefficients.

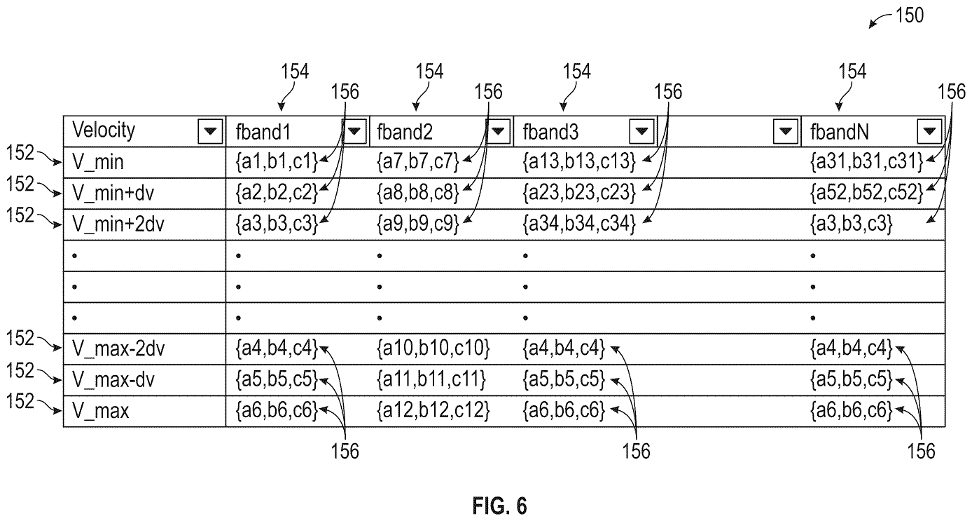

In some embodiments, block 116 comprises creating a FD coefficient lookup table as a function of seismic velocity for each of the frequency bands. To provide an example, and referring briefly to FIG. 6, an exemplary FD coefficient lookup table 150 is shown. Particularly, FD coefficient lookup table 150 includes a plurality of separate rows corresponding to different seismic velocity increments 152 extending between the minimum seismic velocity (Vmin) and the maximum seismic velocity (Vmax) in increments of dV each based on a velocity model from which the FD coefficient lookup table 150 is generated. Additionally, FD coefficient lookup table 150 includes a plurality of separate columns corresponding to different frequency bands 154 corresponding to the previously selected frequency bands (e.g., the frequency bands selected at block 108 of method 100). In this example, FD coefficient lookup table 150 defines a set of optimized FD coefficients 156 (only several of which are labeled in FIG. 6 for clarity) for each seismic velocity increment 152 and frequency band 154. In this example, three separate optimized FD coefficients 156 (a, b, c) are provided for each seismic velocity increment 152 and frequency band 154. The number of optimized FD coefficients 156 may vary from that shown in FIG. 6.

Returning to FIGS. 5A and 5B, at block 118, method 100 includes generating a FD coefficient volume using the velocity model received at block 104. In some embodiments, the FD coefficient volume generated at block 118 is based on an FD coefficient table determined at block 116. In certain embodiments, block 118 comprises inserting the optimized FD coefficients determined at block 116 for each given frequency band into the FD coefficient volume for each grid point of the velocity model (e.g., velocity volume). In this manner, during forward modeling or propagation as will be discussed further herein, the derivatives at each point in the velocity volume may be determined using the coefficients from the FD coefficient volume generated at block 118.

At block 120, method 100 includes determining forward propagated source wavelet to produce modeled seismic data for each of the frequency bands selected at block 108 using the optimized FD coefficients determined at block 116. In some embodiments, the forward propagation is performed using the FD coefficient volume generated at block 118. In this exemplary embodiment, the forward propagation determined at block 118 is based on the optimized FD coefficients determined at block 118 and a wavelet specific to the given frequency band generated at block 122 of method 100. In some embodiments, the wavelets for the different frequency bands generated at block 122 may be individually weighted. By controlling the weights of the different narrowband wavelets generated at block 122, the seismic surveyor may ultimately define or shape the wavelet of the given frequency band as desired based on the requirements of the given application. In this manner, the seismic surveyor may select, for each frequency band, a desired spectral shape. As used herein, the term “spectral shape” refers to the magnitude or amplitude of different frequency components of the wavelet for each frequency band. For instance, in some embodiments, a triangular spectral shape may be selected for the different narrowband wavelets generated at block 122. In some embodiments, each of the narrowband wavelets generated at block 122 may share the same spectral shape.

In some embodiments, after setting initial and boundary conditions, a time-stepping technique may be implemented (e.g., using finite-difference techniques) in which the optimized FD coefficients are used to update displacement/stress at each grid point based on the seismic wave equation, and where, for each time step of the time-stepping technique, the source wavefield is updated and subsequently recorded for each frequency band.

At block 124, method 100 includes determining reverse-time propagated observed seismic data for each of the frequency bands selected at block 108 using the decomposed seismic gathers determined at block 110. For instance, the observed seismic data 102 may be reverse-or back-propagated through the subsurface region for each time-step of a time-stepping technique. In some embodiments, techniques such as reverse time migration (RTM) may be implemented at block 124.

At block 126, the forward propagated generated modeled seismic data determined at block 120 is separately combined, for each selected frequency band, with the reverse-time propagated observed seismic data determined at block 124. By combining at block 126 the forward propagated generated modeled seismic data with the reverse-time propagated modeled seismic data, a plurality or set of frequency band seismic attributes 128, 130, and 132 are generated. In some embodiments, for each frequency band, the forward-propagated source wavefield determined at block 120 is separately cross-correlated (e.g., in order to apply an imaging condition) at block 126 with the reverse-time propagated observed seismic data determined at block 124 and the resulting cross-correlated data is integrated or summed to form the given frequency band seismic attribute 128, 130, or 132.

In this exemplary embodiment, the frequency band seismic attributes 128, 130, and 132 comprise frequency band seismic images; alternatively, in other embodiments, frequency band seismic attributes 128, 130, and 132 may comprise seismic attributes or modeled seismic data other than seismic images. For instance, examples include a method called “Spec Decomp” which takes three separate frequencies (or frequency bands) and color codes them into red-green-blue (RGB) images. Further, a method called “Coherency” uses the lateral similarity or dissimilarity of image pixels to detect faults or other small features in seismic images. Moreover, while only three frequency band seismic attributes 128, 130, and 132 are shown, many additional frequency band seismic attributes may be included in the set thereof (e.g., located between the second frequency band seismic attribute 130 and the final or N frequency band seismic attribute 132) depending on the number of frequency bands selected at block 108.

At blocks 134, 136, and 138, the different frequency band seismic attributes 128, 130, and 132 corresponding to the frequency bands selected at block 108 are separately and individually weighted. For instance, the amplitudes of the different frequency band seismic attributes 128, 130, and 132 may be individually scaled or adjusted as desired by the seismic surveyor in order to minimize noise and artifacts to maximize the accuracy of the ultimate result of method 100. For instance, in some applications, the higher frequencies of a given broadband frequency spectra may be deemphasized relative to lower frequencies of the frequency spectra to minimize noise that may be present at the higher frequencies of the frequency spectra.

By controlling the weights of the different frequency band seismic attributes at blocks 134, 136, and 138 the seismic surveyor may ultimately shape the spectra of the resulting broadband frequency attribute as desired based on the requirements of the given application. In this manner, blocks 134, 136, and 138 allow the seismic surveyor to effectively filter (via the adjusting of the individual weights) different frequency bands to produce a broadband seismic attribute of the highest clarity and fidelity possible.

At block 136, the weighted or shaped frequency band seismic attributes are each combined to thereby generate a weighted or shaped complete seismic attribute at an output layer 140 of method 100. For instance, the shaped frequency band seismic attributes (e.g., weighted frequency band seismic images) may be summed or integrated such that the information contained in the set of weighted frequency band seismic attributes is combined in the shaped complete seismic attribute from block 138. In certain embodiments, the shaped complete seismic attribute from block 138 comprises a shaped seismic image of the subsurface region. Additionally, in some embodiments, the shaped complete seismic attribute 138 has a frequency range equivalent to or equaling the frequency range of the seismic gathers originally determined at block 106 prior to their decomposition at block 110. In some embodiments, the weighting may be derived from the original broadband source wavelet or can be arbitrary depending on the preference of the end user. I would say that the weighting can be chosen to improve resolution of the image/attribute or to reduce the noise content or some combination of both. Also, the weighting can be fully spatially variable so one can be improving resolution in some parts of the image and reducing noise in other parts of the image.

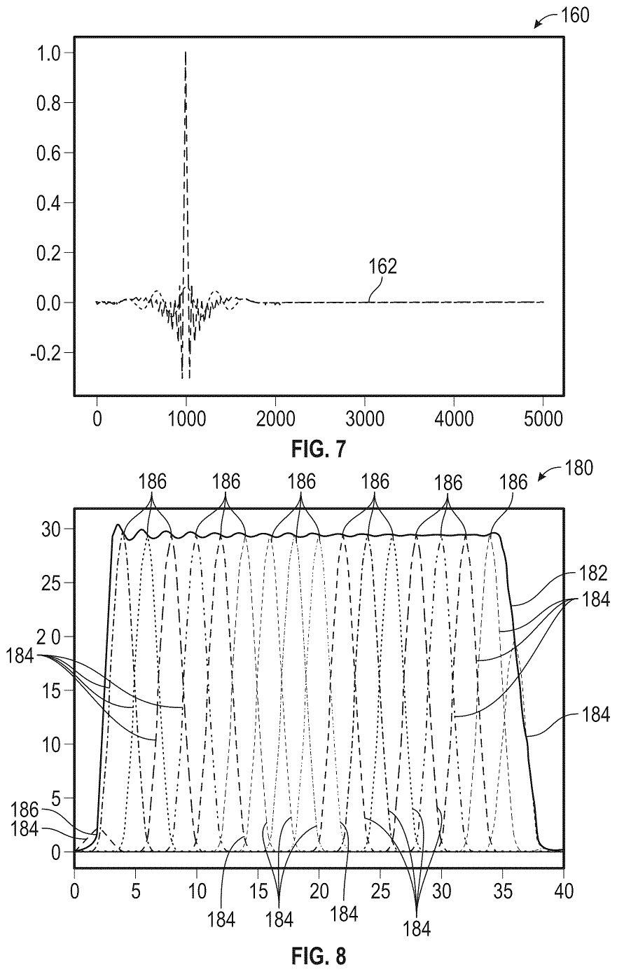

Referring to FIGS. 7-10, an exemplary implementation of some of the features of the method 100 shown in FIGS. 5A and 5B is provided. Particularly, FIG. 7 illustrates a graph 160 of an exemplary synthetic wavelet 162 (e.g., an Ormsby wavelet) in the time-domain. Additionally, FIG. 8 illustrates a graph 180 of the entire or broadband wavelet frequency spectra 182 of the synthetic wavelet 162 shown in graph 180 in the frequency-domain. Additionally, graph 180 illustrates a set of separate seismic frequency bands or wavelets 184 each having a unique central frequency 186 and into which the broadband wavelet frequency spectra 182 may be decomposed.

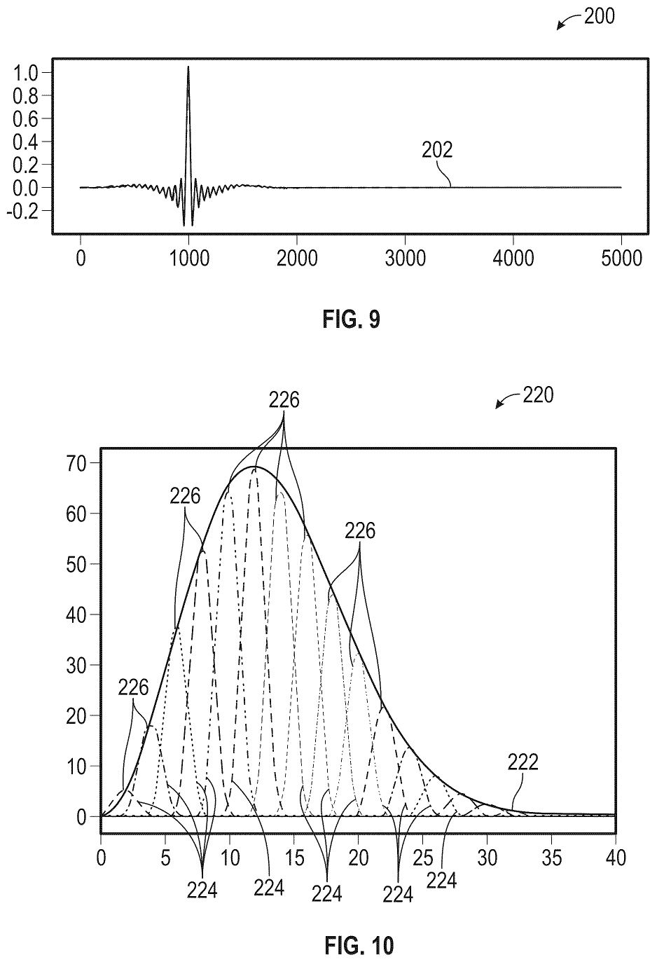

FIG. 9 illustrates a graph 200 of another exemplary synthetic wavelet 202 (e.g., a Ricker wavelet) in the time-domain. Additionally, FIG. 10 illustrates a graph 220 of the entire or broadband wavelet frequency spectra 222 of the synthetic wavelet 202 shown in graph 200 in the frequency-domain. Additionally, graph 220 illustrates a set of separate seismic frequency bands or wavelets 224 each having a unique central frequency 226 and into which the broadband wavelet frequency spectra 222 may be decomposed.

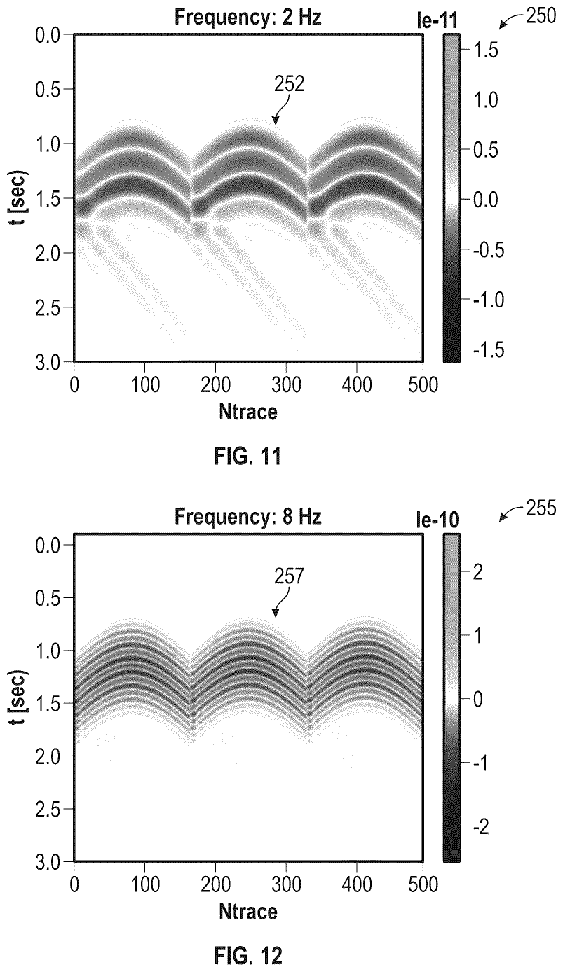

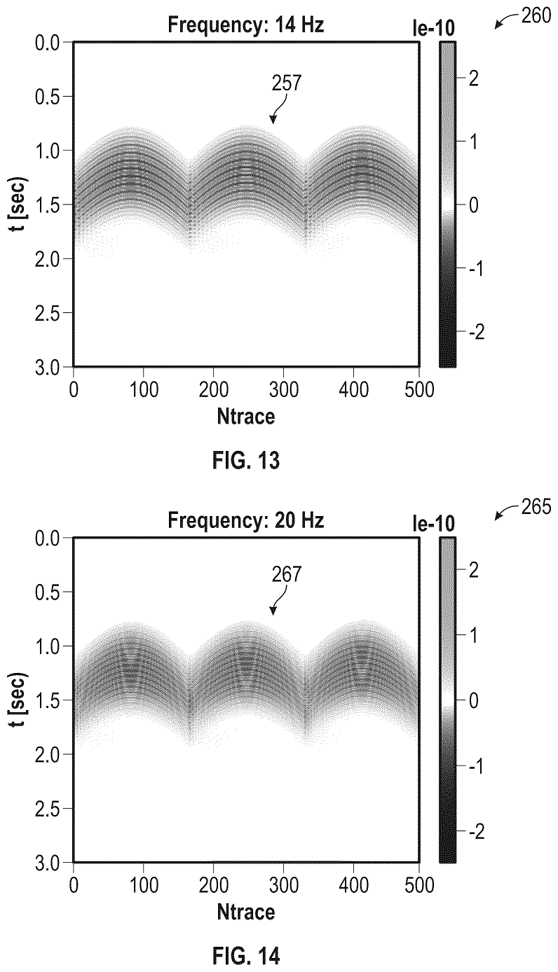

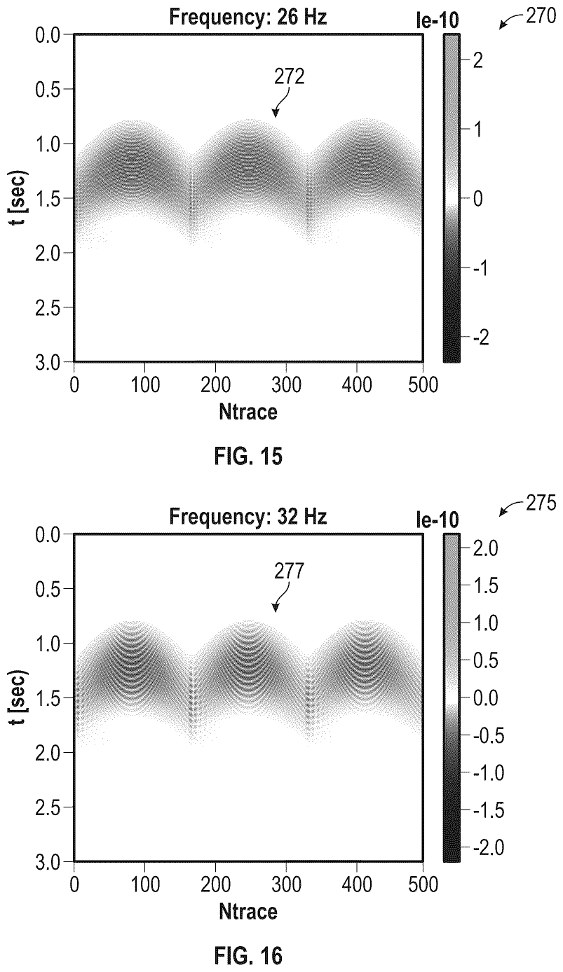

Referring to FIGS. 10-17, another exemplary implementation of some of the features of the method 100 shown in FIGS. 5A and 5B is provided. Particularly, FIGS. 10-15 illustrate graphs 250, 255, 260, 265, 270, and 275, respectively, of modeled seismic data corresponding to a plurality of separate seismic traces for different frequency bands that collectively span a broadband frequency range (e.g., 0.01 Hz to 34 Hz in this example). Specifically, graph 250 of FIG. 11 illustrates modeled seismic data 252 for the 2 Hz frequency band (e.g., a frequency band extending between 0.01 Hz and 4 Hz); graph 255 of FIG. 12 illustrates modeled seismic data 257 for the 8 Hz frequency band; graph 260 of FIG. 13 illustrates modeled seismic data 262 for the 14 Hz frequency band; graph 265 of FIG. 14 illustrates modeled seismic data 267 for the 20 Hz frequency band; graph 270 of FIG. 15 illustrates modeled seismic data 272 for the 26 Hz frequency band; and graph 275 of FIG. 16 illustrates modeled seismic data 277 for the 32 Hz frequency band. It may be noted that the modeled seismic data of the higher frequency bands (e.g., modeled seismic data 272 and 277 shown in graphs 270 and 275) is relatively more blurred than that of the lower frequency bands (e.g., modeled seismic data 257 shown in graph 255).

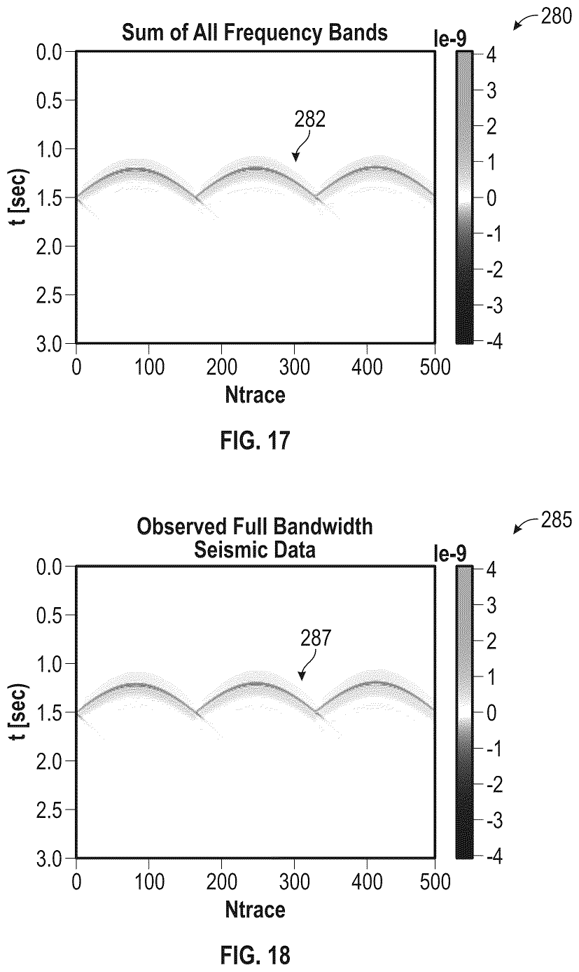

Additionally, FIG. 17 illustrates a graph 280 depicting modeled seismic data 282 summing the modeled seismic data 252, 257, 262, 267, 272, and 277 of graphs 250-275 across the entire frequency range (e.g., from approximately 0.01 Hz to 34 Hz). Further, FIG. 18 illustrates a graph 280 depicting observed seismic data 287 that extends similarly across the entire frequency range (e.g., from approximately 0.01 Hz to 34 Hz) to compare with the modeled seismic data 282 shown in graph 280. Referring now to FIG. 18, an embodiment of a method 300 for generating modeled seismic data from observed seismic data by numerically solving the seismic wave equation across a plurality of separate frequency bands is shown according to some embodiments. At least some, if not all, of the steps or “blocks” of method 300 shown in FIG. 11 may be executed by the computer system 60 shown in FIG. 4, although it is to be understood that at least some of the steps of method 300 may be executed by systems other than computer system 60. Additionally, and as further discussed below, method 300 may incorporate at least some of the features or steps of method 100 described above and shown in FIGS. 5A and 5B.

At block 302, method 300 initially includes receiving observed seismic data (e.g., observed seismic data 102 shown in FIG. 5A) from the subsurface region (e.g., subsurface region 26 shown in FIGS. 2 and 3) captured by one or more seismic receivers (e.g., seismic receivers 36 shown in FIG. 2 or seismic receivers 44 and 46 shown in FIG. 3) as one or more reflected seismic signals (e.g., reflected seismic waveforms 50 shown in FIG. 3). At block 304, method 300 includes decomposing (e.g., decomposing seismic gathers into frequency bands at block 110 shown in FIG. 5A) the observed seismic data into a plurality of separate seismic frequency bands.

At block 306, method 300 includes determining (e.g., determining FD coefficients at block 116 shown in FIG. 5A) a set of FD coefficients by numerically solving a seismic wave equation using a velocity model (e.g., the velocity model from block 104 shown in FIG. 5A) of the subsurface region for each of the plurality of seismic frequency bands. At block 308, method 300 includes determining a set of frequency band seismic attributes (e.g., frequency band seismic attributes 128, 130, and 132 shown in FIGS. 5A and 5B) from the set of FD coefficients. At block 310, method 300 includes combining the set of frequency band seismic attributes to complete seismic attribute (e.g., the complete seismic attribute 138 shown in FIG. 5B).

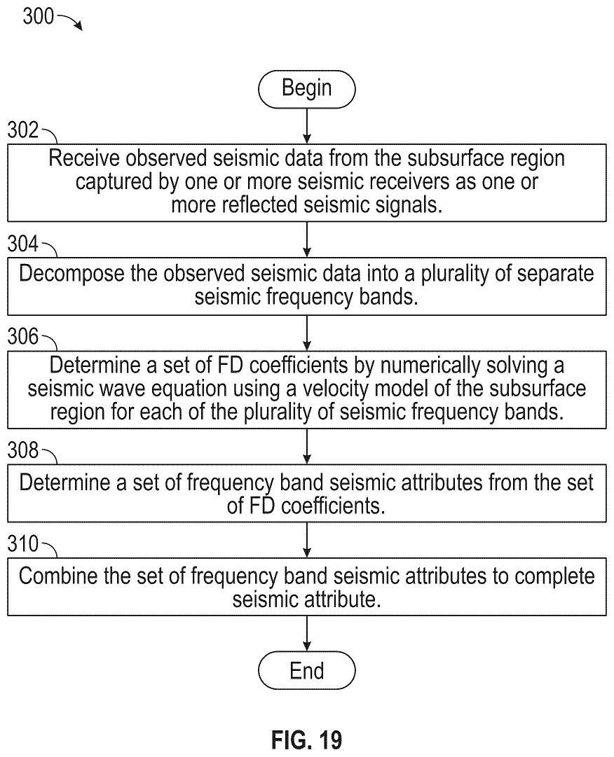

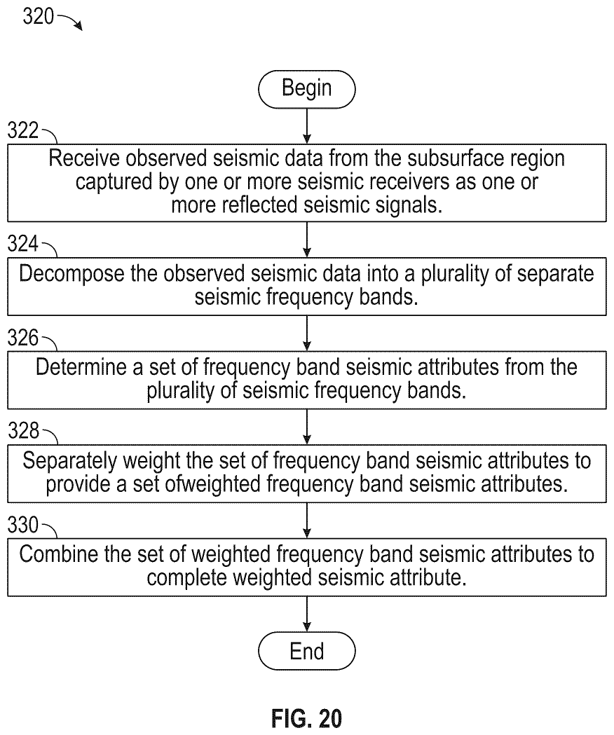

Referring now to FIG. 19, an embodiment of a method 320 for generating modeled seismic data from observed seismic data by numerically solving the seismic wave equation across a plurality of separate frequency bands is shown according to some embodiments. At least some, if not all, of the steps or “blocks” of method 320 shown in FIG. 12 may be executed by the computer system 60 shown in FIG. 4, although it is to be understood that at least some of the steps of method 320 may be executed by systems other than computer system 60. Additionally, and as further discussed below, method 320 may incorporate at least some of the features or steps of method 100 described above and shown in FIGS. 5A and 5B.

At block 322, method 320 initially includes receiving observed seismic data (e.g., observed seismic data 102 shown in FIG. 5A) from the subsurface region (e.g., subsurface region 26 shown in FIGS. 2 and 3) captured by one or more seismic receivers (e.g., seismic receivers 36 shown in FIG. 2 or seismic receivers 44, 46 shown in FIG. 3) as one or more reflected seismic signals (e.g., reflected seismic waveforms 50 shown in FIG. 3). At block 324, method 320 includes decomposing (e.g., decomposing seismic gathers into frequency bands at block 110 shown in FIG. 5A) the observed seismic data into a plurality of separate seismic frequency bands.

At block 326, method 320 includes determining a set of frequency band seismic attributes (e.g., frequency band seismic attributes 128, 130, and 132 shown in FIGS. 5A and 5B) from the plurality of seismic frequency bands. At block 328, method 320 includes separately weighting (e.g., selecting frequency band weights at blocks 134, 136, and 138 shown in FIG. 5B) the set of frequency band seismic attributes to provide a set of weighted frequency band seismic attributes. At block 330, method 320 includes combining the set of weighted frequency band seismic attributes to complete weighted seismic attribute (e.g., the shaped complete seismic attribute 138 shown in FIG. 5B).

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A method for generating modeled seismic wavefields and data as well as propagating observed seismic data by numerically solving the seismic wave equation across a plurality of separate frequency bands, the method comprising:
(a) receiving observed seismic data from a subsurface region captured by one or more seismic receivers as one or more reflected seismic signals;
(b) decomposing the observed seismic data into a plurality of separate seismic frequency bands;
(c) determining a set of finite-difference (FD) coefficients by numerically solving the seismic wave equation using a velocity model of the subsurface region for each of the plurality of seismic frequency bands;
(d) determining forward propagated modeled seismic data using the set of FD coefficients;
(e) determining reverse-time propagated observed seismic data using the set of FD coefficients and the observed seismic data;
(f) determining a set of frequency band seismic attributes from the forward propagated modeled seismic data and the reverse-time propagated observed seismic data; and
(g) combining the set of frequency band seismic attributes to complete seismic attribute.

2. The method of claim 1, wherein the complete seismic attribute comprises a seismic image of the subsurface region.

3. The method of claim 1, wherein a frequency range of each of the plurality of seismic frequency bands is between 3% and 20% of an overall frequency range of the observed seismic data.

4. The method of claim 1, wherein a frequency range of each of the plurality of seismic frequency bands is between 2 Hertz (Hz) and 10 Hz.

5. The method of claim 1, wherein each of the plurality of seismic frequency bands has a unique frequency range that overlaps with the frequency range of another of the plurality of seismic frequency bands.

6. The method of claim 1, wherein (c) comprises applying an optimization algorithm to iteratively minimize an error between an analytical velocity and a numerical seismic velocity for each of the plurality of seismic frequency bands.

7. The method of claim 6, wherein the optimization algorithm comprises a least-squares optimization algorithm.

8. The method of claim 1, wherein each of the set of frequency band seismic attributes have a triangular spectral shape.

9. The method of claim 1, wherein (b) comprises:
(b1) determining a seismic gather from the observed seismic data, the seismic gather extending across an overall frequency range; and
(b2) decomposing the seismic gather into a plurality of separate seismic frequency bands each having a frequency range contained in the overall frequency range.

10. The method of claim 1, wherein (f) comprises:
(f1) determining forward propagated modeled seismic data for each of the plurality of seismic frequency bands using the set of FD coefficients;
(f2) determining reverse-time propagated modeled seismic data for each of the plurality of seismic frequency bands using the set of FD coefficients; and
(f3) determining the set of frequency band seismic attributes by combining the forward propagated modeled seismic data with the reverse-time propagated seismic data.

11. The method of claim 1, further comprising:
(h) separately weighting the set of frequency band seismic attributes to provide a set of weighted frequency band seismic attributes;
wherein (e) comprises combining the set of frequency band seismic attributes to complete seismic attribute.

12. A method for generating modeled seismic data from observed seismic data by numerically solving the seismic wave equation across a plurality of separate frequency bands, the method comprising:
(a) receiving observed seismic data from a subsurface region captured by one or more seismic receivers as one or more reflected seismic signals;
(b) decomposing the observed seismic data into a plurality of separate seismic frequency bands;
(c) determining a set of frequency band seismic attributes from the plurality of seismic frequency bands;
(d) separately weighting the set of frequency band seismic attributes to provide a set of weighted frequency band seismic attributes; and
(e) combining the set of weighted frequency band seismic attributes to provide a complete seismic attribute.

13. The method of claim 12, wherein the complete seismic attribute comprises a seismic image of the subsurface region.

14. The method of claim 12, wherein a frequency range of each of the plurality of seismic frequency bands is between 3% and 20% of an overall frequency range of the observed seismic data.

15. The method of claim 12, wherein a frequency range of each of the plurality of seismic frequency bands is between 2 Hertz (Hz) and 10 Hz.

16. The method of claim 12, wherein each of the plurality of seismic frequency bands has a unique frequency range that overlaps with the frequency range of another of the plurality of seismic frequency bands.

17. The method of claim 12, wherein (d) comprises adjusting a spectral shape of one or more of the set of frequency band seismic attributes.

18. The method of claim 12, wherein (d) comprises adjusting an amplitude of a central frequency of one or more of the set of frequency band seismic attributes.

19. A system comprising:
a one or more processors; and
a storage device coupled to the one or more processors, the storage device configured to store instructions that, when executed by the one or more processors, configure the one or more processors to:
(a) receive observed seismic data from a subsurface region captured by one or more seismic receivers as one or more reflected seismic signals;
(b) decompose the observed seismic data into a plurality of separate seismic frequency bands;
(c) determine a set of finite-difference (FD) coefficients by numerically solving a seismic wave equation using a velocity model of the subsurface region for each of the plurality of seismic frequency bands;
(d) determine forward propagated modeled seismic data using the set of FD coefficients;
(e) determine reverse-time propagated observed seismic data using the set of FD coefficients and the observed seismic data;
(f) determine a set of frequency band seismic attributes from the forward propagated modeled seismic data and the reverse-time propagated observed seismic data; and
(g) combine the set of frequency band seismic attributes to complete seismic attribute.

20. The system of claim 19, wherein at least one of a frequency range of each of the plurality of seismic frequency bands is between 3% and 20% of an overall frequency range of the observed seismic data, and the frequency range of each of the plurality of seismic frequency bands is between 2 Hertz (Hz) and 10 Hz.
